(19) United States
(12) Patent Application Publication
(10) Pub. No.: US 2010/0270443 A1
(43) Pub. Date: Oct. 28, 2010

(54) Support stand for the handling & storage of elastomeric balloons

(76) Inventors: Randy Scott Holcomb, Fort Worth, TX (US); Kimberly Ann Holomb, Fort Worth, TX (US)

Correspondence Address: Randy Holcomb, 2625 Purple Sage Trail, Fort Worth, TX, 76179, US

(21) Appl. No.: 12/431,091

(22) Filed: Apr. 28, 2009

(51) Int. Cl. F16M 11/04

(52) U.S. Cl. 248/176.1

(57) ABSTRACT

A three-dimensional support stand comprised of a plurality of support members and a horizontal surface that includes a plurality of slots. Elastomeric balloons are suspended from the support stand by means of the neck roll that is produced in the manufacturing process of said elastomeric balloons.

### RELATED US PATENT DOCUMENTS

None

### FIELD OF THE INVENTION

This invention pertains to a support stand. More specifically, the invention pertains to a special article support stand for the storage and handling of elastomeric balloons treated with an aqueous flight extending product.

### DESCRIPTION OF THE RELATED ART

The current practice of using helium filled elastomeric balloons as decorations or as a delivery item (e.g., substitute for floral bouquets for delivery)has an inherent problem due to the limited buoyant lifetime of said elastomeric balloons.

### SUMMARY OF THE INVENTION

The present invention is a support stand for the storage and handling of elastomeric balloons treated with an aqueous solution that extends the buoyant lifetime of the elastomeric balloon. The support stand has a plurality of slots in which the elastomeric balloons are suspended by the neck roll prior to inflation. The support stand loaded with elastomeric balloons may then be placed in an airtight container for storage. This allows the balloons to be treated well in advance of when they are required for use.

The support stand may be constructed in a variety of ways and with various quantities of slots. The support stand may be constructed of plastic, metal or other suitable material. There is no known device existing which addresses the issue of handling and storage of elastomeric balloons treated with an aqueous solution that extends the buoyant life of said elastomeric balloons. Presently most users of said aqueous solution inject it into the elastomeric balloon and then prop the elastomeric balloon up in a bowl, cup or other container to prevent the aqueous solution from flowing out of the elastomeric balloon. The support stand is an aid in solving this leakage problem by holding the elastomeric balloon upright by means of the neck roll of said elastomeric balloon when it is suspended from the support stand after insertion into one of the slots contained therein.

### BRIEF DESCRIPTION OF THE DRAWINGS

FIGS. 1 & 2 are perspective views of the support stand.

FIG. 3 is a view from beneath the support stand.

FIG. 4 is an end view of the support stand.

### DESCRIPTION OF THE PREFERRED EMBODIMENT

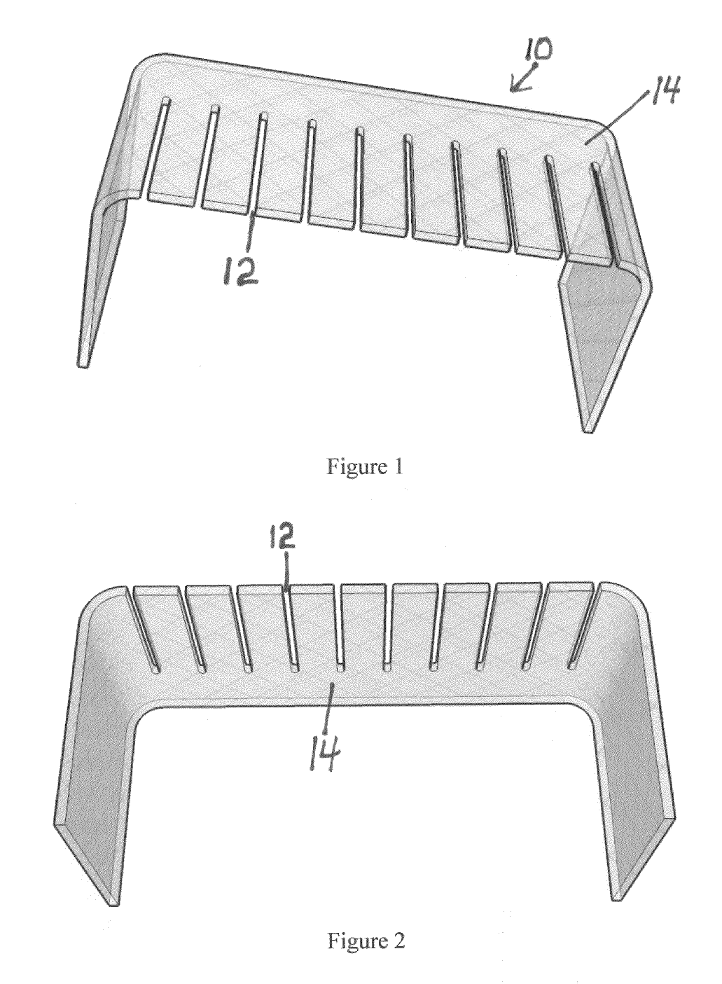

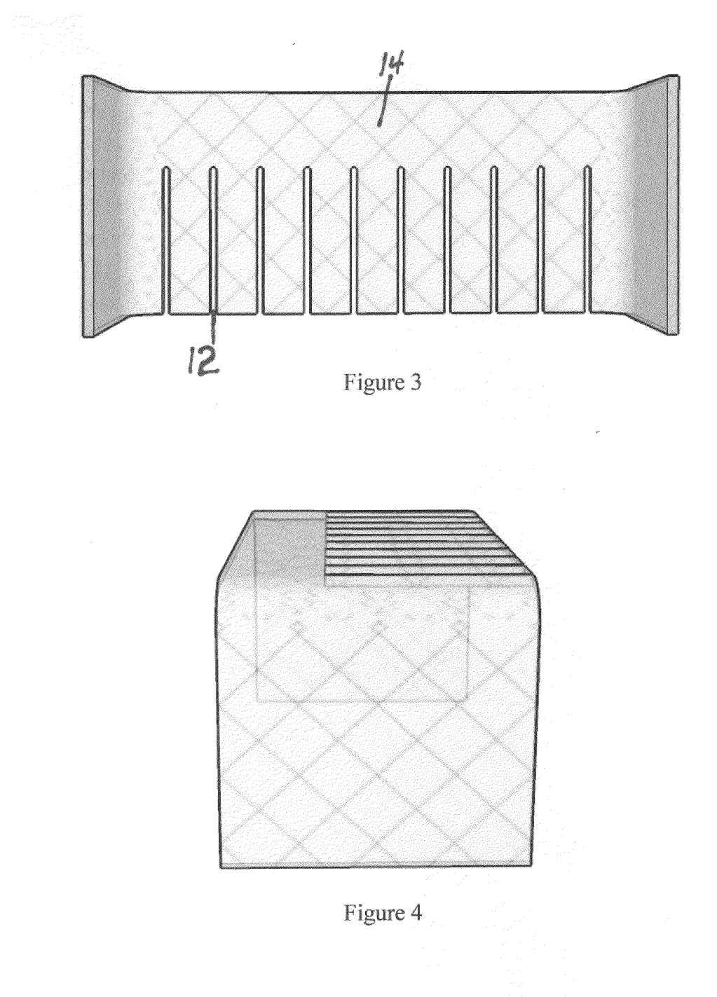

The support stand 10 which is shown in FIG. 1 through FIG. 4 is preferably comprised of a one piece body of polycarbonate or other plastic and may be constructed of sheet material or injection molded. The support stand has slots 12 that are either molded in or CNC machined to the proper specifications for retaining the elastomeric balloons. The support stand is generally shaped like an inverted “U” with the horizontal plane 14 extended to a length adequate to contain the plurality of slots 10. The current preferred embodiment consists of a plurality of slots 10 each of which can accommodate a plurality of elastomeric balloons.

We claim:

1. A support stand for elastomeric balloons comprising:
a) a plurality of supporting members; and
b) a plurality of slots for retention of elastomeric balloons.

2. The support stand as defined in claim 1 wherein:
a) said slots are of the proper width to support, by the neck roll, said elastomeric balloons filled with the aqueous solution.
b) said slots are equally spaced.
c)said slots are of sufficient length to accommodate a plurality of elastomeric balloons.

3. The support stand as defined in claim 1 wherein:
a) said supporting members are of sufficient height to allow suspension of said elastomeric balloons below the horizontal surface of said support stand.
